(19) United States
(12) Patent Application Publication
(10) Pub. No.: US 2011/0115766 A1
(43) Pub. Date: May 19, 2011

(54) Energy efficient display system

(75) Inventors: Louis Joseph Kerofsky, Camas, WA (US); Sachin G. Deshpande, Camas, WA (US); Chang Yuan, Vancouver, WA (US); Xinyu Xu, Vancouver, WA (US); Scott J. Daly, Kalama, WA (US)

(73) Assignee: Sharp Laboratories of America,Inc.

(21) Appl. No.: 12/590,954

(22) Filed: Nov. 16, 2009

(51) Int. Cl. G06F 3/038; G09G 5/10

(52) U.S. Cl. 345/207; 345/212; 345/690

(57) ABSTRACT

A method for displaying an image on a display includes receiving a two dimensional image to be displayed on the display. The two dimensional image may be modified using a non-photorealistic technique and the contrast is reduced. At least one of the modifying and reducing is based upon a power usage factor. Also, the system may modify the power usage based upon audio, presence, smart meters, and brightness preservation.

### CROSS-REFERENCE TO RELATED APPLICATIONS

Not applicable.

### BACKGROUND OF THE INVENTION

The present invention relates generally to an energy efficient display system.

There is a desire among consumers of televisions to watch television content while also being environmentally conscious by reducing the resulting power consumption of the television. In the context of smart grid linked operation, televisions receive signals from a smart meter grid or an energy manager and adjust their operation accordingly. In response to receiving such signals, generally two types of actions are taken. The first action is a time shifting where the television schedules its operation to occur during off peak times. The second action is a demand responsive reduced load operation where the power drawn by the television is reduced by lowering its performance level.

What is desired is a an energy efficient display system while maintaining an image that is readily observable and preferably has pleasing audio.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates a system for reducing power consumption.

FIG. 2 illustrates power consumption.

FIG. 3 illustrates power control.

FIG. 4 illustrates LCD TV backlight.

FIG. 5 illustrates a target backlight.

FIG. 6 illustrates audio power measurements.

FIG. 7 illustrates dynamic range compression.

FIG. 8 illustrates an audio system.

FIG. 9 illustrates low complexity with remote emulation.

FIG. 10 illustrates low complexity with remote pass through.

FIG. 11 illustrates black lines on a white background.

FIG. 12 illustrates a system for color NPR image.

FIG. 13 illustrates viewing modes.

FIG. 14 illustrates viewing modes power reduction.

FIG. 15 illustrates key feature highlighting with a non-photorealistic rendering technique.

### DETAILED DESCRIPTION OF PREFERRED EMBODIMENT

In an attempt to make televisions more energy efficient, the principal focus has been on improving device efficiency when in use. Unfortunately, in many cases such improved device efficiency may be insufficient to reach the power reductions desired. Accordingly, in some situations, aggressive power consumption reduction may be desired, e.g., in response to load reduction information from the smart meter. Other aggressive power consumption reductions may be based upon the viewing activity of the viewer. For example, people may only be ‘monitoring’ the television while waiting for something they really want to watch to come on. In some cases people may be in the same room but occupied with another activity, occasionally glancing at the television when some audio suggests something of interests, and they take a glance at the television. In other cases people may walk away from the television and leave television on. Therefore, when such viewer inactivity is detected in front of the television, the television may invoke different power consumption techniques to lower the power consumption, since the viewer will not be as particular about the image quality. In other cases it may be desirable to modify the power used by the audio system.

Under an aggressive power reduction mode, a television is usually dramatically dimmed by reducing the maximum luminance to a lower value. By reducing the maximum luminance, the image presented on the display tends to become very dark with very low contrast (due to black level being held generally constant by the ambient light and display's reflectivity). For backlit liquid crystal televisions (LCD), the luminance reduction is achieved by a reduction in the backlight luminance. For plasma or organic light emitting diode based displays, the luminance is reduced by reducing the power consumed by the active display elements. Other display technologies may reduce power consumption using similar techniques. In any case, the video content and features become less visible to the observer when the display is substantially dimmer when displaying the same image data, making the viewing experience less enjoyable. The principal effect of such dimming is that the contrast of the image is significantly reduced (e.g., normally pegged at black) and many image features that convey important content of the scene falls below or nearly below the visual threshold of the viewer. In the case of mobile devices viewed outdoors with low backlight power, the contrast becomes reduced, but is pegged at white (i.e., the black level rises).

In order to provide a recognizable image while significantly reducing the power consumption, it was determined that rather than attempting to maintain the fine details of the image, it is desirable to modify the image content to be displayed using a non-photorealistic rendering technique. The non-photorealistic rendering technique modifies the image to be more generally cartoon like in its appearance. Such cartoon like images tend to have generally more pronounced edges, regions of more generally uniform color, and/or generally defined by larger region boundaries of the image being defined with edges. The non-photorealistic rendering technique thus may use image processing techniques to identify features of the image in a manner that is constrained by the power usage available. Such cartoon like images may likewise or alternatively include low amplitude details that are rendered as relatively constant, gradual edges that are rendered as steeper edges; and/or darker outlines being rendered along edges.

The power reduction system for a television may include techniques for making the television responsive to a smart meter, connected to smart electricity grid, for providing one or more power savings modes. The power savings mode may include video processing, backlight reduction techniques, and/or power savings by suitable audio processing. In the context of smart grid linked operation, the television receives signals from a smart meter grid, a central server (e.g., any suitable computing device), and/or an energy manager, and adjusts its operation accordingly. In general, two types of actions are taken in response to signals from the smart meter. The first type of action is a time shifting of its operations so that activities occur during off peak times. The second type of action is to reduce the power drawn by the appliance by lowering its performance level.

For a particular implementation of a non-photorealistic rendering technique for video the desirable features to be rendered are preferably selected. In three dimensional shape and depth perception, the desirable features for shape and depth perception include silhouette and contour lines, some contour features such as T-junction and X-junction, ridge and valley lines, and line of curvature. However, the computation of these features require three dimensional data represented in the form of polygons, meshes or three dimensional volume data, and it requires principal directional directions and a surface normal which is computationally intensive to determine. Accordingly, such features are not directly applicable to a system where only two-dimensional data is available and low computational complexity is available.

Rather than relying on three dimensional data, preferably the system incorporates a local-data-driven non-photorealistic rendering technique using two dimensional data, such as television broadcast data. The rendering technique preferably uses less than 10% of full power consumption, more preferably less than 5% of full power consumption, and more preferably less than 2% of full power consumption. The rendering technique preferably extracts and highlights prominent two-dimensional image features to better convey the image content to the observer. The prominent image features may include intensity discontinuity (i.e. edges) and local shape features such as T-junctions and X-junctions. The extracted image features are emphasized in the resulting image. To highlight the essential information, the technique may render prominent image features with the assistance of local contrast stretching. The color of the highlighted edges may be adapted to the local image content.

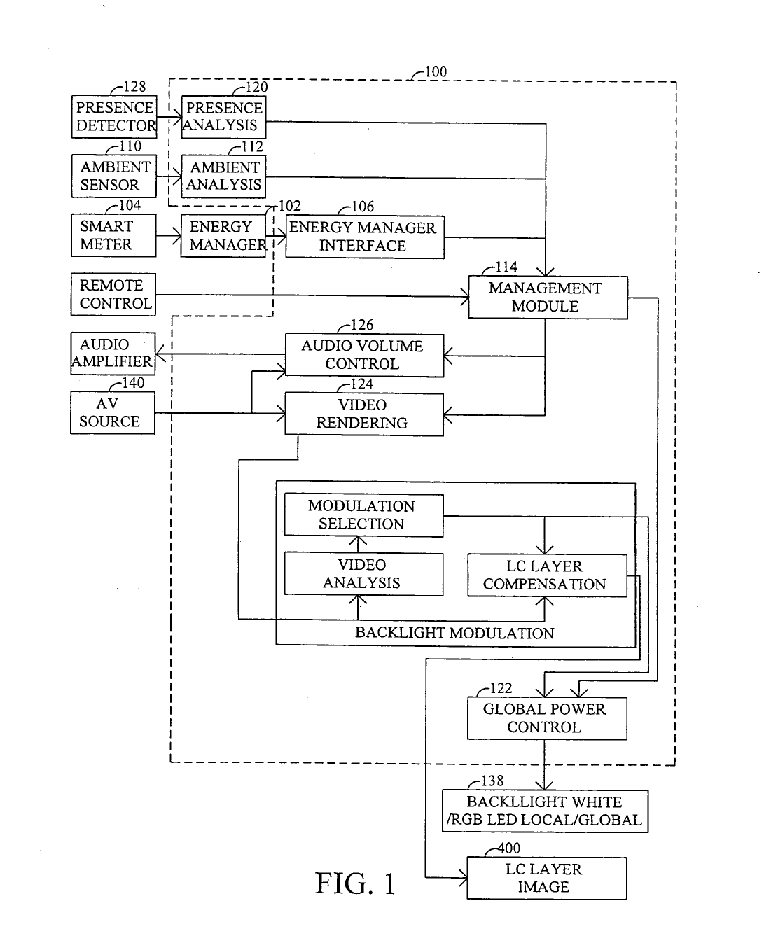

Referring to FIG. 1, the television may communicate though an energy manager interface 106 with an energy manager 102 and/or smart meter 104. Any suitable communication protocol may be used, such as for example, WiFi, Ethernet, powerline, and/or ZigBee. Data from the energy manager interface 106 is provided to a management module 114. Data from the energy manager 102 and/or smart meter 104 may be used by the management module 114 to modify the power usage of the television and/or associated devices.

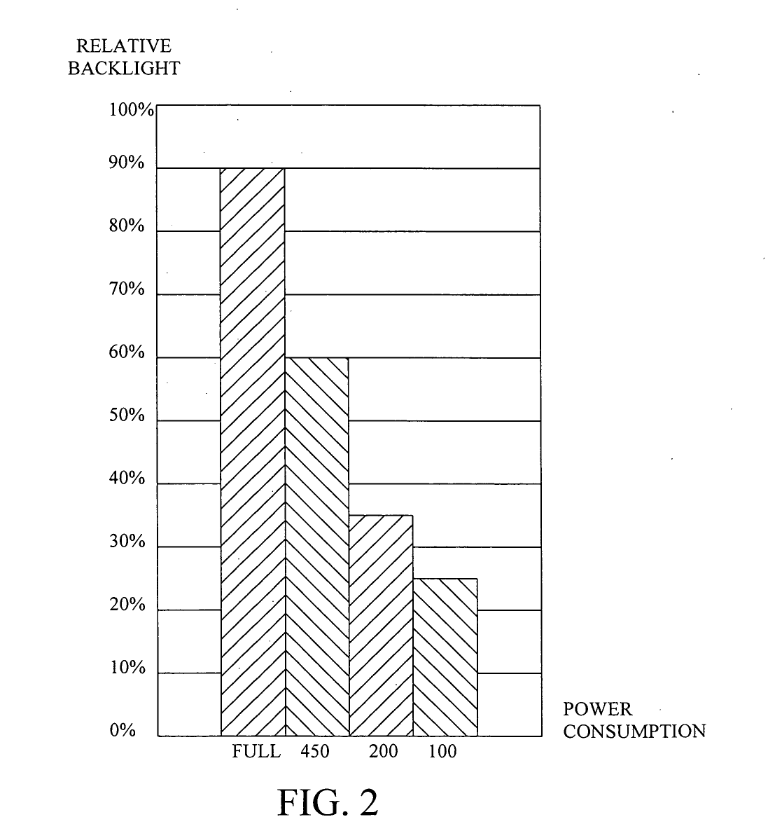

An ambient sensor 110 senses the ambient lighting levels which are received by an ambient analysis module 112. The management module 114 may receive signals from the ambient analysis module 112 to determine, at least in part, sufficient display brightness under low lighting conditions and/or modification of power usage of the television and/or associated devices. This information can be used by the management module 114 to control display brightness, for example, and hence power consumption. An example of power consumption variation with ambient light is illustrated in FIG. 2. It is noted as the ambient light decreases from “full”, to 450, to 200, and to 100, that the backlight energy consumption is likewise reduced.

The management module 114 may also receive input from a presence analysis 120 which receives input from a presence detector 128 to determine, at least in part, sufficient display brightness and/or modifications to power usage of the television and/or associated devices. Based on the multiple inputs from 106, 112, and/or 120, the television 100 selects actions in response for a global power control 122, video rendering 124, and audio volume control 126. Tables 1 and 2 summarizes one set of input and output options for the management module 114.

TABLE 1
Management module inputs

| Input Module | Parameter(s) |
|---|---|
| Energy Manager | Grid Status |
| Ambient Analysis | Desired White Point |
| Presence Analysis | Viewer Presence Likelihood |

TABLE 2
Management module outputs

| Output Module | Parameter(s) |
|---|---|
| Global Power Control | Average Power Target |
| Audio Volume Control | Average Power Target |
| Video Rendering | Rendering Mode |

The management module 114 may select average power targets and/or rendering mode based upon the power usage desired. The management module 114 may likewise provide data indicative of, in general, power usage to the global power control 122, audio usage to the audio volume control 126, and/or video rendering to the video rendering module 124.

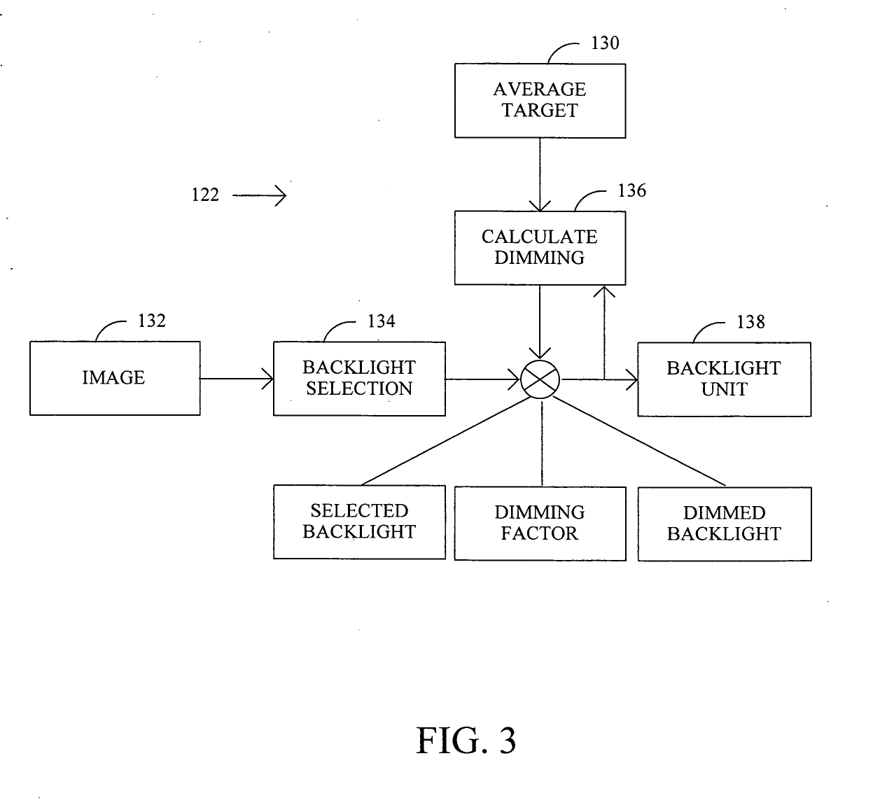

An exemplary global power control 122 is shown in FIG. 3. Based on desired average power consumption 130 from the management module 114, the global display brightness may be modified using a closed control loop. The global power control 122 may use the input image 132 upon which to select the backlight level 134. Based upon the selected backlight 134 and an average target 130, the global power control 122 may calculate a dimming factor 136. After the dimming factor 136 is determined, data may be provided to the backlight unit 138 to control the amount of backlight illumination desired for the display.

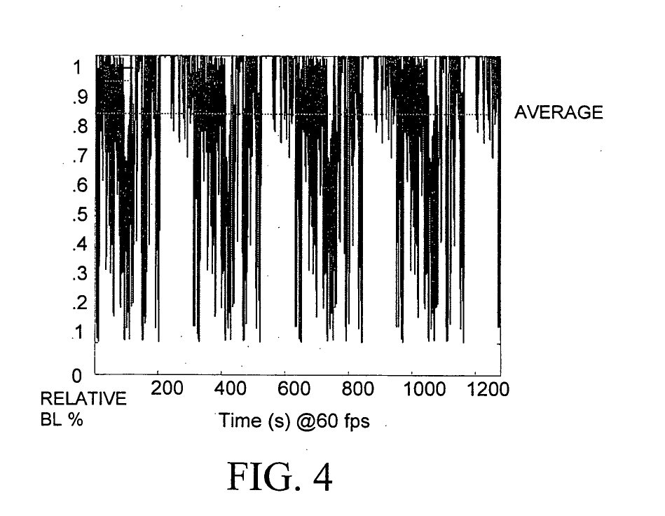

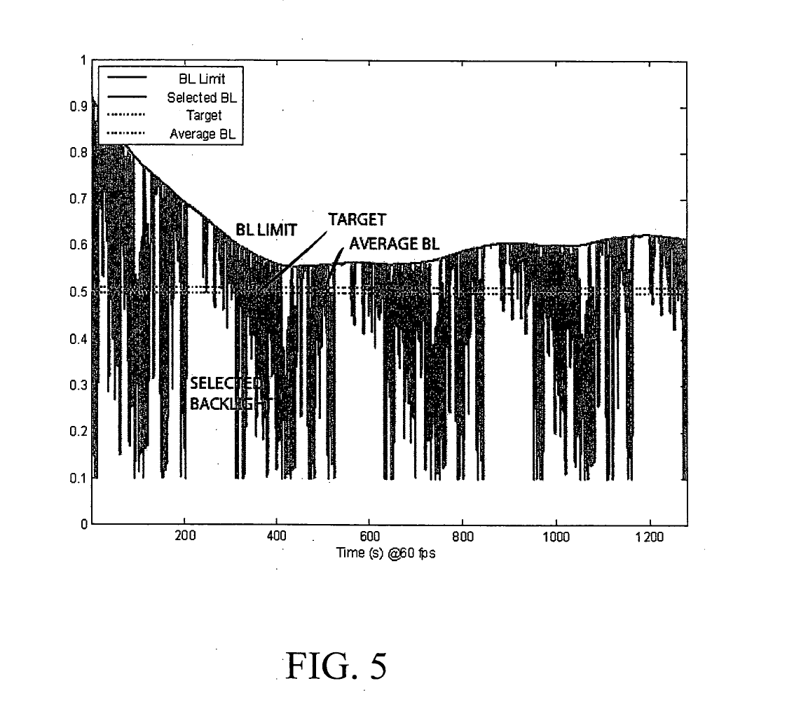

Referring to FIG. 4, the power consumption may be adjusted on a per frame basis, or group of frames, or otherwise, based upon the content to be displayed. It is noted that an average backlight of slightly more than 80% is frequently used given the bright and dark regions of typical image content. The power use is primarily driven by the characteristics of the video. The closed loop power control shown in FIG. 3, may be used to lower the average target value to a lower value, such as 50% by adaptively dimming the display output. Any other suitable power control technique may likewise be used. A dimming profile may be used to adaptively meet a desired target average backlight. An exemplary dimming profile is shown in FIG. 5, where the power use per frame is the product of the dimming profile and the backlight selected.

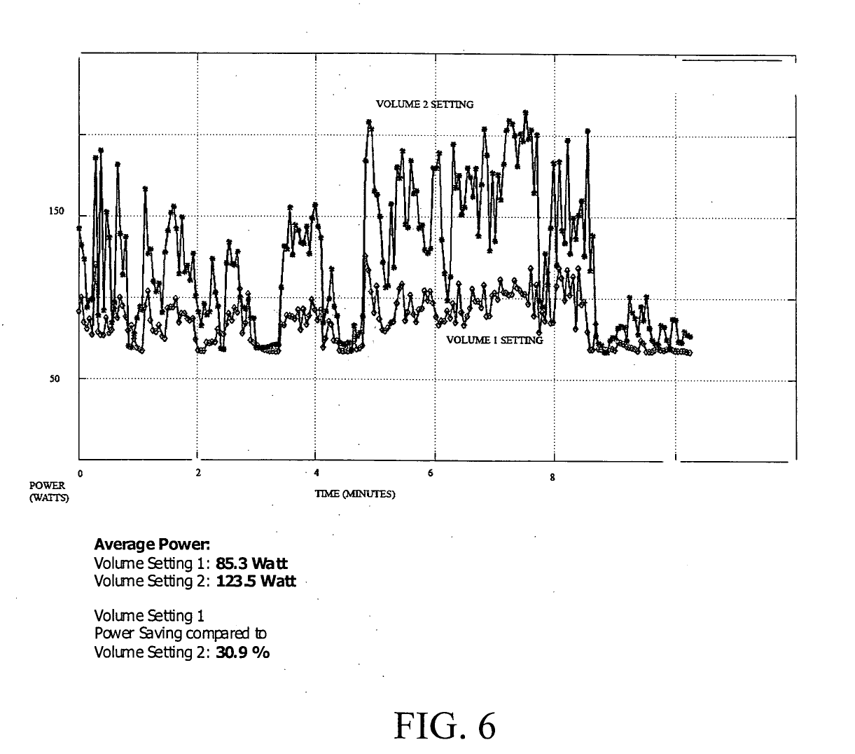

Another technique for reducing the power consumption is to consider peripheral components frequently attached to, and in some cases controlled by, the television. One type of such component is the audio system associated with the television 100. The power consumption of audio with surround sound when using an audio-visual receiver (audio amplifier) can be significant. FIG. 6 illustrates an exemplary audio power consumption measurement with a television and external audio-visual receiver (AVR) with 5.1 output and six loudspeakers for the same content at two different volume settings. From FIG. 6 it can be observed that:

power consumption with external AVR can be significant;

power consumption varies within an audio program content;

mean power consumed can be controlled by the volume level setting.

An audio power control technique may be used to control the audio dynamic range to reduce overall power usage. One aspect that the system may control is the volume control, such as setting a volume level for each of the channels. As can be observed from FIG. 6, the volume level setting can effectively control the power consumed by audio subsystem, including audio-visual receiver and all the loudspeakers. To achieve a desired power savings, a calibration of the audio subsystem may be done to analyze power consumed at different volume level settings. Any suitable technique may be used, such as one of the following examples.

First, in one embodiment the audio calibration may be done on a set of training audio sample data and an average power consumption may be noted at different volume level settings. Then during the playback phase, the volume level setting may be automatically adjusted to a desired level based on the training phase measurements.

Second, in another embodiment the power consumed for an audio input with constant audio code values may be determined. This may be repeated for different constant audio code input values. Then while playing audio content, an analysis of its audio code values provides an estimate of power being consumed. A modified volume level settings may be selected based on the desired target power consumption.

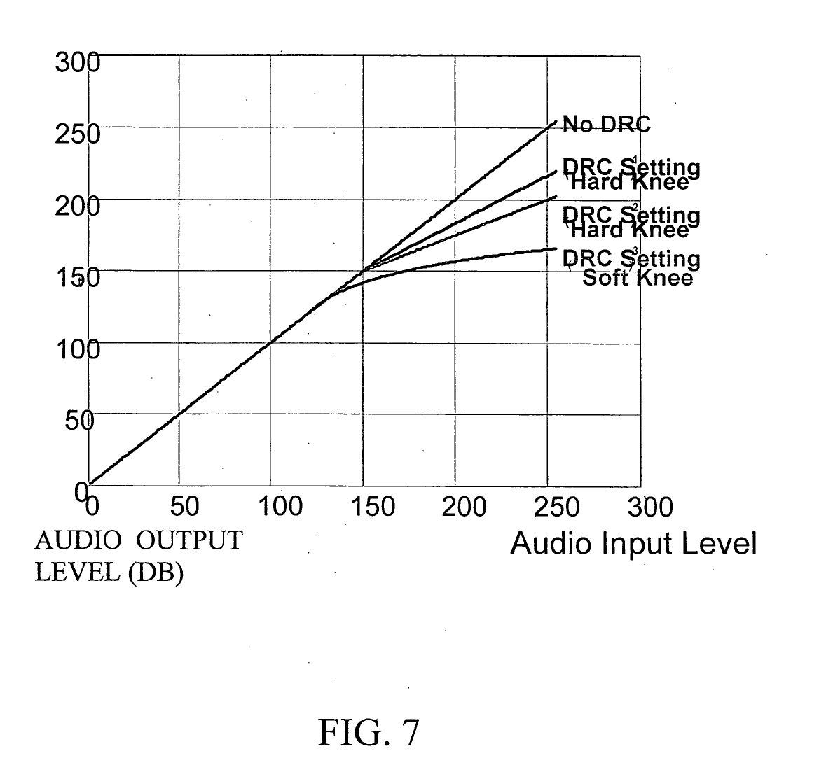

Referring to FIG. 7, a dynamic range control adjustment may be applied before or after (described below) down mixing on one or more of the input audio channels and/or output audio channels. The dynamic range control (DRC) component may reduce the volume level of loud sounds which are above a threshold input level (in dB). The volume reduction may be omitted to sounds below the threshold input level in some cases a mild volume reduction may also be applied to sounds below the threshold. The threshold may be pre-selected or may be adaptively selected based analysis of the input audio content A hard or soft knee may be utilized for the volume reduction near the threshold. This controls the characteristics of the input to output level mapping curve.

In an audio system the audio content may have X different input audio channels. A down mixing component may take as input X input audio channels and may output Y output audio channels, with Y≦X.

In one embodiment, the number of output channels Y may be selected based on the target power consumption desired. In another embodiment, the down-mixing operation may drop one or more input audio channels to arrive at the target number of Y output audio channels. In another embodiment, a down-mixing operation may mix two or more input audio channels to one audio output channels to arrive at Y audio output channels. Referring again to FIG. 1, the system may include an audio decoder 140 that decodes the input audio stream to obtain discrete audio input channel data. The audio volume control 126 may include dynamic range compensation to analyze the dynamic range information. In some cases, the input audio stream may include dynamic range compensation information in the stream. As an example, in the case of the ATSC Digital Television Standard carrying AC3 audio stream, each encoded audio block may contain a dynamic range control word (dynrng) that may be used to alter the level of the audio output. In addition, the dynamic range compensation may determine a dynamic range compensation curve (such as those illustrated in FIG. 7) to apply to one or more of the input audio channels.

The audio volume control 126 may analyze the audio volume levels of each input audio channel (e.g., input surround channels). The audio volume control 126 may compute and/or select shift curves to emphasis and de-emphasis curves {C₁, C₂, . . . , C_{X}, C_{X+1}} to apply on individual input audio channels. The computation may be performed using information from volume analysis module and/or dynamic range compensation module. Audio channel level shift operation with down-mixing may use information from audio channels level shift curves applied on each input audio channels to generate output audio channels. Thus Aⱼ^{O}=Cⱼ(Aⱼ^{I}) ∀j, where Aⱼ^{O}, Aⱼ^{I} respectively denote the audio output and audio input channel j and Cⱼ is the audio channel level shift curve for channel j.

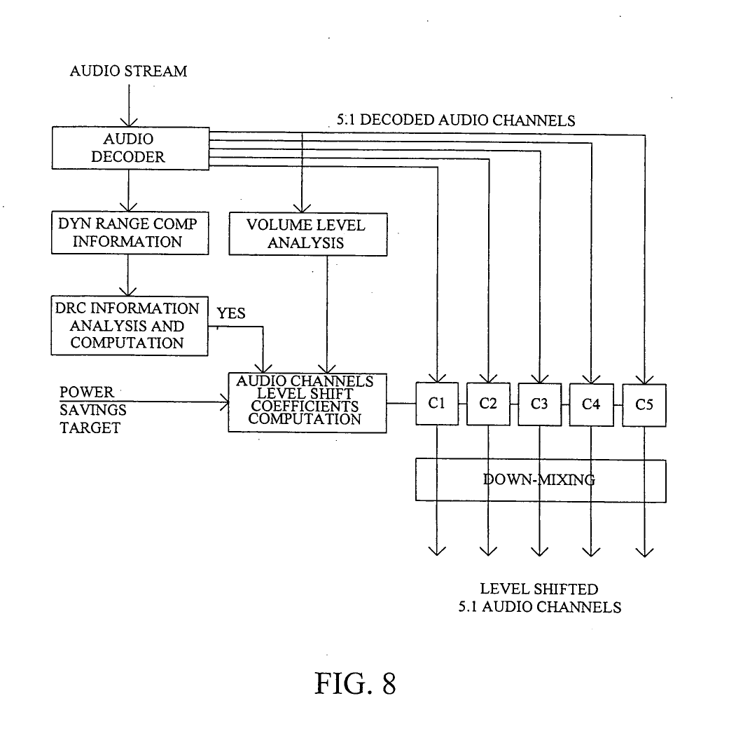

Referring to FIG. 8, an exemplary audio system has same number of output audio channels as the number of input audio channels. A down-mixing operation 170 may be included to arrive at lesser number of audio output channels compared to number of input audio channels. In some embodiments the uncompressed audio output signal may be transmitted on “audio output” terminal. In an alternative embodiment the audio output channels may be encoded before transmission on the “audio output” terminal.

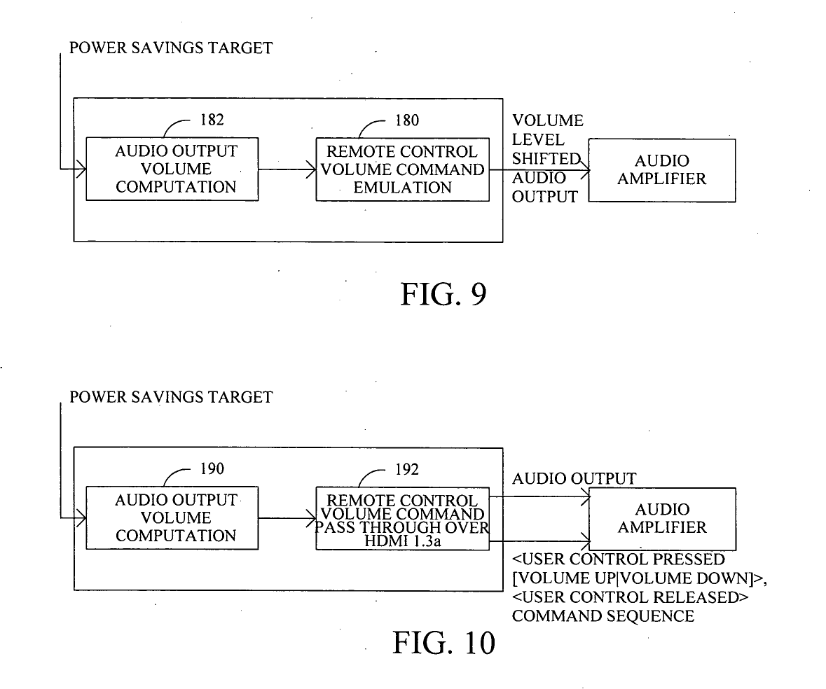

FIG. 9 illustrates a low complexity system using remote control emulation where the sound volume that is output from TV on the “Audio Output” terminals is adjusted internally. Such a low complexity system may include, for example, output audio volume computation 182 and remote control volume command emulation 180. The audio output volume computation may be sent using digital audio output and/or optical audio output and/or RCA audio output terminals. The internal volume adjustment may be performed by emulation of remote control volume increase and/or decrease commands. This uses as input parameters the current volume level for audio and the target volume level for audio computed by “audio output volume computation” module 182. It then internally generates commands which emulate the behavior of a remote control 180 which changes the volume from current audio volume level to the desired target audio volume level.

Referring to FIG. 10, the remote control may be emulated in other ways. An audio output volume module 190 may compute the volume level settings for each of the audio output channels. The remote control volume command 192 may be passed through the HDMI channel (or other channel) as an input parameter to the current volume level for audio and the target volume level may be determined. The system then may internally generate commands which consist of a sequence of remote control commands, such as volume up and volume down, to be passed over the HDMI channel.

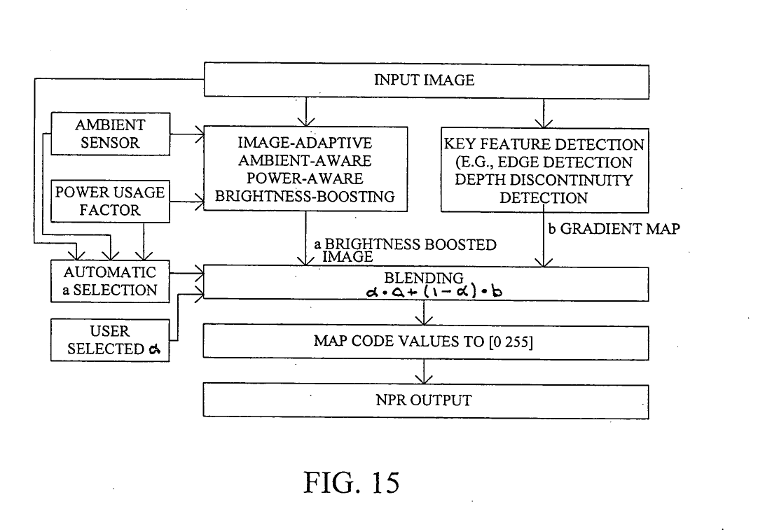

FIG. 15 shows a technique for highlighting key image features with non-photorealistic rendering technique. The technique consists of two paths: brightness boosting (left path) and gradient estimation (right path).

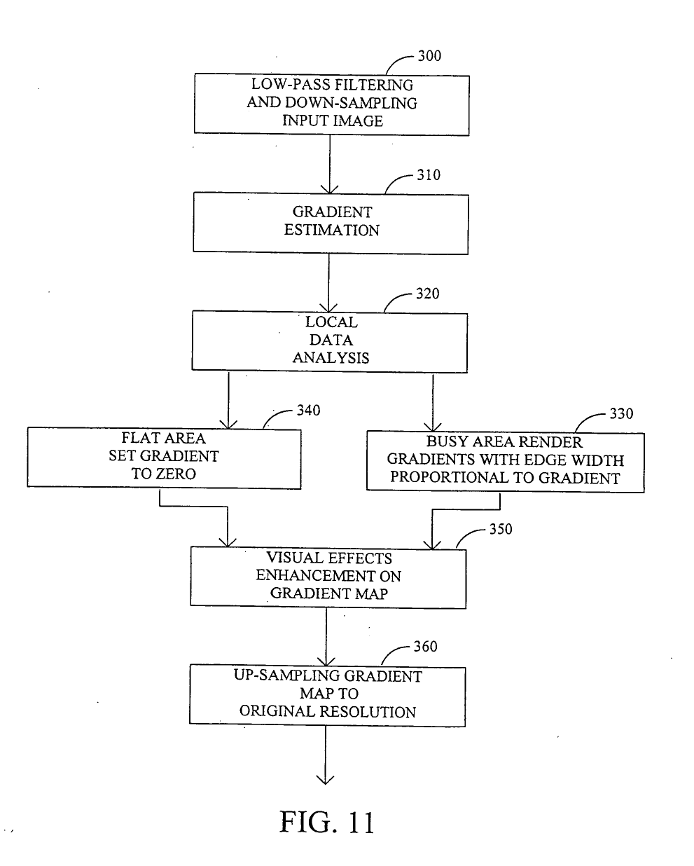

The left path boosts the brightness of the input color image with an image-content-adaptive, ambient-aware and power-aware brightness boosting technique. The inputs to the brightness boosting path include the original input image, the ambient level given by the ambient sensor (110 in FIG. 1) and the power usage factor given by the management module (114 in FIG. 1). With these input information, the brightness of the input image is boosted to compensate for the loss of the contrast and the dimming of the display which is caused by the dramatic power (i.e. backlight) reduction. The amount of brightness boosting amount depends on the image content (e.g. image color histogram), the ambient level and the power usage factor. In one embodiment, the darker the input image, or the higher the ambient level, or the more the power (backlight) is reduced, the more the input image is brightened. The output of this path is a brightness boosted image. The right path estimates gradient from original input image and performs additional post-processing to the gradient map. The input of this path is the original image and the output of this path is a continuous-tone gradient map. One embodiment of estimating gradient is shown in FIG. 11.

The input image resolution may be quite high (e.g., larger than full HD resolution), therefore the system preferably low-pass filters the image and down-samples it to a lower resolution 300 to facilitate near real-time processing with limited computation resources. In addition to save computational resources, the low-pass filtering and down-sampling also has the benefit of suppressing noise in the input image, which, if otherwise unprocessed, may react to subsequent processing. An alternative for removing noise is to decompose the image signal into two channels with nonlinear sieve filter or bilateral filter.

In a second step, the system detects edges/contours using gradient estimation 310. The first order gradient can be extracted with various types of gradient operators including Canny, Sobel, Prewitt, and Roberts. In order to extract true contours with large gradients rather than noisy segments, the system may use a large spatial support when computing the gradient at each pixel. For example, the gradient at point p can be set to the largest gradient with a local search in the left, right, top and bottom direction. Depending on the effectiveness of the first order gradient, discontinuities of the first order gradient can also be extracted with a Laplacian operator.

In a third step, the system may analyze the data 320 activity of a local neighborhood to determine how to render the detected edges/gradients: for busy neighborhood 330 where the average of gradients is larger than a threshold, T, the edge will be rendered with its width proportional to its gradient; for flat area 340 where the average of gradients is smaller than T, the detected edges will be removed and white background will be rendered. The threshold T is defined to be the average of the gradients in the entire image.

The system may enhance 350 the visual effects by smoothing the rendered gradients so that the contours are blended with the background and the broken edges are linked. Other enhancement technique may also be used such as local contrast stretching. The system may up-sample the edge map 360 back into the original resolution.

The output from these two paths, one is the gradient and the other is the brightened input, are blended by a linear weighted average. The blending coefficients α is either determined by an automatic a selection algorithm which depends on input content, ambient level and power usage factor, or is selected by the user. The final NPR result is obtained by mapping the code values of the blended image into the range of [0 255].

Another technique receives the input image, first modifies it to an NPR image having the full (or substantially full) range of system code values (e.g., 0-255 for an 8 bit system), and then sends it to the driving stages 400 of the LCD. A separate control signal (dependent on the presence detector's result for viewer's state) goes to the backlight, and indicates whether it should be reduced. This dims the image date on the LCD, but can save substantial power. For Plasma, OLED, or other self-emitting displays, the NPR image may be rescaled to lower amplitude values (from 0-255 to 0-40, for example). The lower max code values results in a dimmer luminance on the display, but with an advantageous power savings reduction.

In addition to the previously described main modes of utilizing an NPR image, a pair of exemplary techniques for generating the NPR image (whether for the 0-255 range or for a pre-dimmed range) are illustrated.

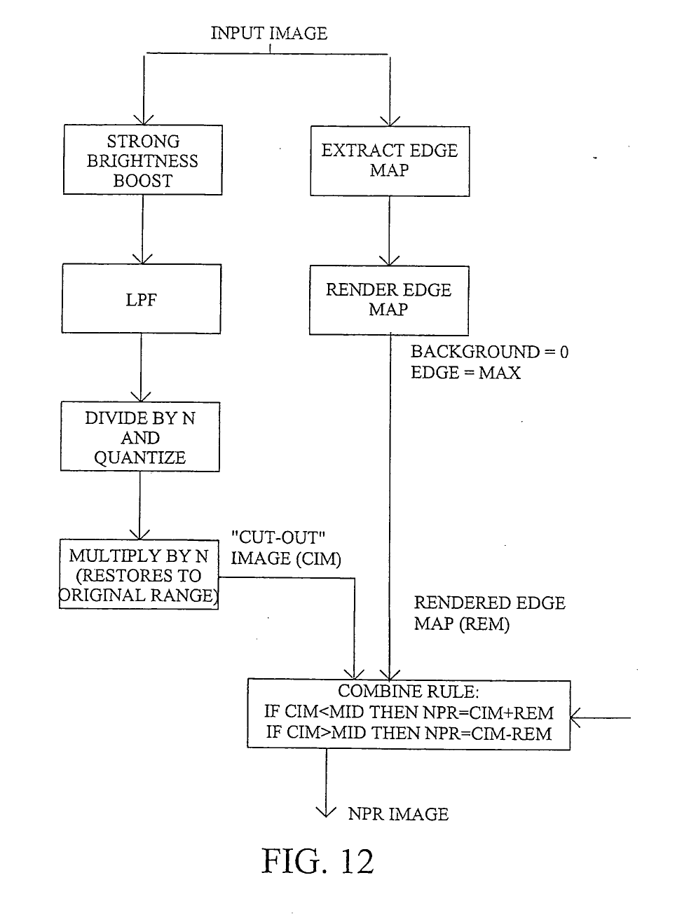

Referring to FIG. 12, in another embodiment which may be preferable for lower contrast applications, the black lines are on a white background, or the reverse polarity. If higher contrast occurs in the display then a color version may be preferred. In this approach an edge map (generally binary, but not necessarily) and an a cut-out image are computed in separate paths and then combined with a threshold dependent addition. The combination process puts white lines over dark image regions and dark lines over bright image regions for increasing feature visibility. The regions underlying the lines (corresponding to salient edges) are derived from a cut-out image process, shown in the left-side path.

The primary steps to generate the cut-out image include first applying a nonlinear tone scale to strongly boost the images brightness. Then a LPF may be applied to smooth the image and reduce low amplitude textures. The filter may end up being quite large. If the input image is already strongly filtered and down sampled then this step may be omitted. Next the number of effective gray levels are reduced to change the image to essential shapes, so that it looks like a multiple color paper cut-out version of the image. One technique is to divide the image by N (typically 64, for an image with range 0-255), quantize (e.g., round to a nearest integer) and then rescale back to the original range (this example will give an image with 4 cutout gray levels per color). The rendered edge map may be performed by the following operations (1) low-pass filtering and downsampling; (2) gradient estimation; (3) local data analysis; and (4) render edge with width proportional to gradient.

The cut-out image is added to the rendered edge image, where the sign of the edge image per pixel is dependent on the per pixel gray level of the cut-out image. That decision is set by the parameter MID, which may be 128 (out of a range of 0-255). The preferred value depends on the display's tone scale. The result will be a non-photorealistic rendered image where there will be dark lines over bright regions, and bright lines over dark regions. This will increase the visibility of the lines and regions, when viewed on a low contrast display (it is low contrast because the power is strongly reduced, making the white max level lower, and hence closer to the black level).

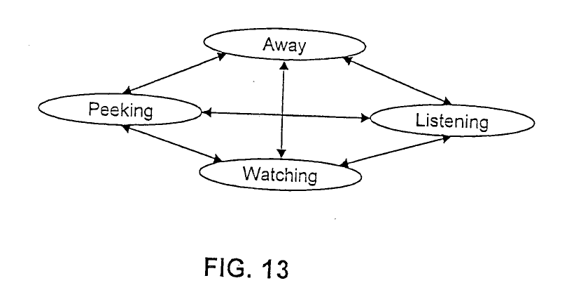

Referring to FIG. 13, power savings may likewise be selected based upon the viewer presence. The viewers may use the television in different ways at different times. For example, viewers may watch the TV for a long time, or viewers may be doing other activities while taking a look at the TV intermittently. Therefore different energy management schemes may be applied to save the energy without affecting the viewers' normal viewing.

Referring to FIG. 13, four exemplary viewer presence modes reflect different ways of using the TV by the viewers. First, the viewer may not be present in the viewing environment for a pre-defined period of time, referred to as “away” mode. Then the viewers will enter the viewing environment and look at the TV directly and stay in front of the TV, referred to as “watching” mode. When the viewers are doing other activities and may look at the display intermittently, the mode is referred to as “peeking” mode. The last presence mode is referred to as “listening” mode when the viewers do not look at the TV at all and may only want to listen to the audio outputs. The viewer presence mode may be changed from one state to the other states, due to the change of viewer's activities and/or the content on the TV.

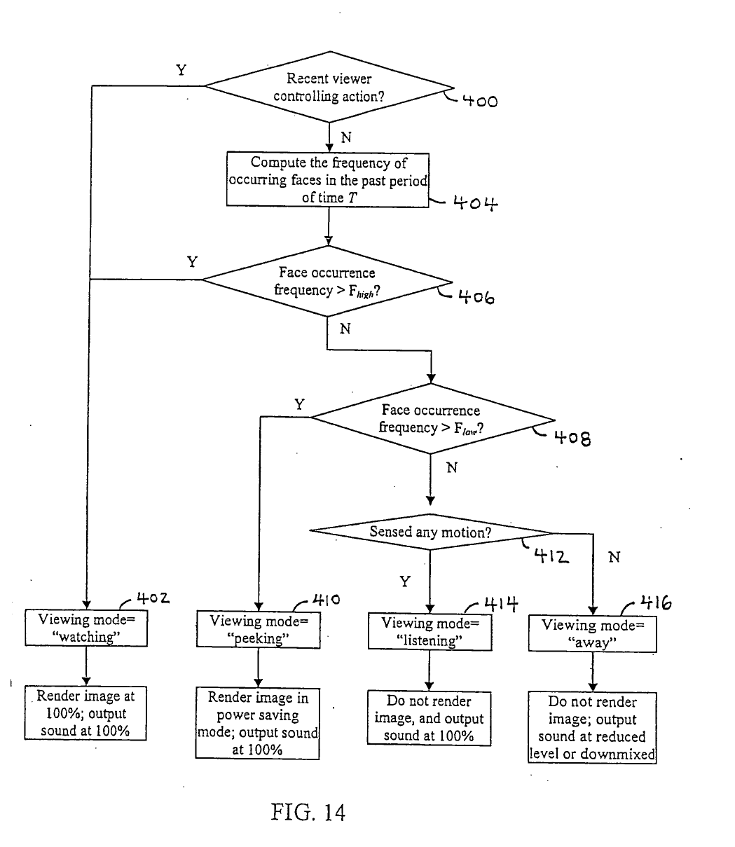

Referring to FIG. 14, in order to detect the current viewer presence mode, one or more motion sensors may be employed with the TV. One type of sensor may be a passive infra-red (IR) motion sensor with a very small number of pixels (e.g., 2 or 4 pixels). The IR motion sensor is able to detect a moving viewer. However, if the viewer remains still in the viewing environment, the IR motion sensor cannot detect the viewer.

Another type of sensor is an infra-red or visible light sensitive camera with a higher pixel resolution (e.g., 640×480 pixels) than the IR motion sensor. The camera takes periodic snapshots of the environment and can be used to detect human faces in front of the display. The face detection rate is higher when the viewer is looking at the camera directly and lower when the viewer turns his/her head away. This difference in the detection rate can be used to determine if the viewer is looking at the TV directly.

One embodiment is to use an infra-red motion sensor to sense the viewers' motion. However, the single IR motion sensor is sensitive to all kinds of motion and cannot differentiate the different presence modes. Another embodiment is to use an infra-red or visible light camera to sense the viewing environment in front of the TV. The camera can be used to recognize different viewer presence modes.

The preferred embodiment is to combine the infra-red motion sensor and the infra-red camera to sense both the viewer's motion and the viewing environment. Both sensors may be installed on the bezels of the TV or inside the TV pixel array. The motion sensor is turned on all the time and reports whether there is motion in the past second. The camera is turned on at a user-specified interval ΔT (e.g., 30 seconds) and captures a snapshot of the viewing environment. The face detection technique may be applied to find the faces in the image.

A face occurrence frequency is computed for a period of time:

$$freq\_face = \frac{\# of images with detected faces}{\# of total images in the past T seconds} \times 100 \%$$

The face occurrence frequency is a number between 0% and 100%. Two thresholds, F_{high} and F_{low}, may be used to decide the viewer presence mode based on the frequency. If there is a viewer constantly watching the TV, the frequency will be higher than F_{high}; otherwise if the viewer is away, the frequency will be close to zero and lower than F_{low}. For the other two viewer presence modes, the frequency will lie between F_{high} and F_{low}. Typical numbers of F_{high} and F_{low} can be 80% and 20%. These numbers can be adjusted by the viewers.

Based on the combined sensors an energy management scheme is provided. First, the technique checks 400 if there is any recent viewer controlling action in a past period of time T (e.g., 30 seconds). If the viewer makes any controlling action (e.g., pressing any buttons on the TV remote), it is assumed that the viewer is paying attention to the TV and the presence mode is “watching” 402. Otherwise, the face occurrence frequency 404 is computed and used to make the decision. If the face occurrence frequency 406 is higher than F_{high}, the viewer is looking directly at the TV more often, therefore in the “watching” mode 402.

Otherwise the face occurrence frequency 408 is compared to F_{low}. If the viewer is looking at TV intermittently (frequency>F_{low}) 408, he/she may be doing some other activities; the mode is “peeking” 410. If the viewer seldom looks at TV (frequency>F_{low}), the IR motion sensor is used to decide the mode. If there is any motion sensed 412 by the IR motion sensor, the viewers may be moving in the viewing environment and want to hear the sound from the TV; the mode is “listening” 414. Otherwise, if there is no detected face and no motion in the scene, the viewers are probably not in the environment and the mode is “away” 416. In some cases, the system will attenuate lower frequency, values to reduce power consumption.

When the viewer presence mode changes, the corresponding energy management scheme is also changed. For the “watching” mode 402, viewers want to have the full viewing experience and therefore both image and sound are generated at 100%. When the viewers are only “peeking” 410, the images can be rendered at an energy saving mode and the sound is still output at 100%. For the viewers who are only “listening” 414, the images are turned off on the TV while the sound is still generated at 100%. If the viewers are “away” 416, the image is turned off to save energy while the sound level can be reduced or even set at 0%, depending on the viewer's presence. The audio control module uses the input from the viewer presence module to make further decisions.

As a general matter, the system may include a pair of image rendering techniques. One of the techniques may be the non-photorealistic rendering technique as previously described. Another of the techniques may be generally known brightness preservation techniques. The brightness preservation techniques tends to attenuate higher luminance values in a manner while not similarly attenuating lower luminance values. The curves for the brightness preservation techniques tend to be similar in appearance to FIG. 7. The different image rendering techniques may be used in conjunction with one another to achieve improved results. The brightness preservation is preferably used at power levels of 0-10% power reduction or 0-20% power reduction without the use of a non-photorealistic rendering technique. The non-photorealistic rendering is preferably used at power levels of 80-˜100% power reduction or 90-˜100% power reduction without the use of a brightness preservation technique. The region between higher brightness preservation technique and the lower non-photorealistic rendering technique may include one or more of the techniques.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method to display an image on a display comprising:
(a) receiving a two dimensional image to be displayed on said display;
(b) modifying said two dimensional image using a non-photorealistic technique;
(c) reducing the contrast of said display for displaying said modified non-photorealistic two dimensional image;
(d) wherein at least one of said modifying and reducing is based upon a power usage factor.

2. The method of claim 1 wherein the maximum luminance of said display is decreased.

3. The method of claim 1 wherein the minimum luminance of said display is increased.

4. The method of claim 1 wherein said modifying is performed when said power usage factor is greater than 80% of full power consumption.

5. The method of claim 1 wherein said display is a plasma display.

6. The method of claim 1 wherein said display is an organic light emitting diode display.

7. The method of claim 1 wherein said non-photorealistic technique results in modification of said image to be more generally cartoon like in its appearance.

8. The method of claim 7 wherein said cartoon like image is modified to include generally more pronounced edges.

9. The method of claim 7 wherein said cartoon like image is modified to include regions of generally uniform color.

10. The method of claim 7 wherein said cartoon like image is modified to include generally larger region boundaries being defined with edges.

11. The method of claim 1 wherein said power usage factor is based upon a smart meter.

12. The method of claim 11 wherein said smart meter obtains data from a central server.

13. The method of claim 11 wherein said display modifies its operation to schedule events during other times.

14. The method of claim 1 wherein said display uses less than 10% of full power consumption.

15. The method of claim 1 wherein said display uses less than 5% of full power consumption.

16. The method of claim 1 wherein said display uses less than 2% of full power consumption.

17. The method of claim 1 wherein said power usage factor is based upon an ambient light sensor.

18. The method of claim 1 wherein said power usage factor is based upon a presence determination.

19. The method of claim 1 further comprising modifying the audio signals provided from associated audio components of said display.

20. The method of claim 19 wherein said audio signals are digital.

21. The method of claim 19 wherein the dynamic range of said audio signals is modified.

22. The method of claim 19 wherein the volume of said audio signals is modified.

23. The method of claim 19 wherein a down-mixing operation drops at least one audio output channel.

24. The method of claim 1 wherein said display includes a management module that receives inputs from (1) an energy manager module, (2) an ambient light analysis module, (3) a presence analysis module.

25. The method of claim 24 wherein said management module provides outputs to (1) an audio volume control module; (2) a video rendering module; (3) a power control module.

26. The method of claim 1 wherein said display include a power control system that determines data to be provided to a backlight of said display based upon said two dimensional image and illumination data.

27. The method of claim 26 wherein said illumination data is used to calculate a dimming factor.

28. The method of claim 1 wherein said power usage factor include dynamic range compression of audio curves.

29. The method of claim 1 wherein said power usage factor includes down-mixing audio channels.

30. The method of claim 29 wherein said down-mixing includes dynamic range compression.

31. The method of claim 29 wherein said down-mixing includes omitting at least one selected channel.

32. The method of claim 1 wherein said power usage factor is based upon the emulation of a remote control.

33. The method of claim 1 wherein said modifying of said image is based upon feature detection.

34. The method of claim 33 wherein said modifying of said image is based upon edge detection and depth discontinuity.

35. The method of claim 34 wherein said modifying is further based upon a blending operation.

36. A method to display an image on a display comprising:
(a) receiving a two dimensional image to be displayed on said display;
(b) reducing the power consumption of said display for displaying said two dimensional image;
(c) wherein said reduction of said power consumption is based upon a sensor sensing the presence of a viewer.

37. The method of claim 36 said presence is based upon a selection between at least two of the following:
(a) rendering full image and full sound;
(b) rendering reduced power usage image and full sound;
(c) rendering no image and full sound;
(d) rendering no image and reduced power sound.

38. The method of claim 37 wherein said presence is based upon all four options.

39. A method to display an image on a display comprising:
(a) receiving a two dimensional image to be displayed on said display;
(b) reducing the power consumption of audio components associated with said display for displaying said two dimensional image;
(c) wherein said reduction of said power consumption is based upon a sensor.

40. The method of claim 39 wherein said sensor is a smart meter.

41. The method of claim 39 wherein said sensor is a ambient light sensor.

42. The method of claim 39 wherein said sensor is a presence detector.

43. A method to display an image on a display comprising:
(a) receiving a two dimensional image to be displayed on said display;
(b) modifying said two dimensional image using a non-photorealistic technique if a power usage factor is greater than a first threshold;
(c) modifying said two dimensional image using a brightness preservation technique if said power usage factor is lower than a second threshold;
(d) wherein said modifying with said non-photorealistic technique when said power usage factor is greater than said first threshold is free from including said brightness preservation technique;
(e) wherein said modifying with said brightness preservation technique when said power usage factor is lower than said second threshold is free from including said non-photorealistic technique.

44. The method of claim 43 wherein said first threshold is greater than 80% of full power consumption.

45. The method of claim 44 wherein said first threshold is greater than 90% of full power consumption.

46. The method of claim 43 wherein said second threshold is less than 20% of full power consumption.

47. The method of claim 46 wherein said second threshold is less than 10% of full power consumption.

48. A method to display an image on a display comprising:
(a) receiving a two dimensional image to be displayed on said display;
(b) modifying the display of said two dimensional image based upon a power usage factor;
(c) wherein said power usage factor is based upon a smart meter.

49. The method of claim 48 wherein said smart meter is interconnected to a network.

50. The method of claim 49 wherein said smart meter is interconnected to a server.

51. The method of claim 1 wherein a modulation of said display is associated with said power reduction
